(19) United States
(12) Patent Application Publication
(10) Pub. No.: US 2009/0028418 A1
(43) Pub. Date: Jan. 29, 2009

(54) SYSTEM AND METHOD FOR INSPECTING ELECTRONIC DEVICE

(75) Inventors: Huang Howard, Shanghai (CN); Tseng Farmer, Shanghai (CN)

Correspondence Address: Muncy, Geissler, Olds & Lowe, PLLC, P.O. BOX 1364, FAIRFAX, VA, 22038-1364, US

(73) Assignee: INVENTEC APPLCANCES CORP.

(21) Appl. No.: 12/060,001

(22) Filed: Mar. 31, 2008

(30) Foreign Application Priority Data
Jul. 27, 2007 (TW) 096127394

(51) Int. Cl. G06K 9/00

(52) U.S. Cl. 382/141

(57) ABSTRACT

The invention discloses a method for inspecting an electronic device to reduce the consumption of testers' labor and time and testers' erroneous or careless judgment, and increase the test efficiency and reliability. Furthermore, the method of the invention can help to maintain or modify the test standard immediately and feedback the condition of the electronic device to the production line. The method of the invention includes the steps of: (A) storing a plurality of standard parameters related to the electronic device; (B) measuring a plurality of inspecting parameters, wherein each inspecting parameter corresponds to one of the standard parameters; (C) comparing each of the inspecting parameters with the corresponded standard parameter and setting a processing status of the electronic device according to a first criterion; and (D) receiving the comparison results of step (C) and generating an adjusting information according to the comparison results.

### BACKGROUND OF THE INVENTION

1. Field of the Invention

This invention relates to a system and a method for inspecting electronic devices and, more particularly, to a system and a method for inspecting electronic devices during the production process.

2. Description of the Prior Art

Portable electronic devices, such as a PDA (personal digital assistant), an MP3 walkman, and a PND (portable navigation device), has been making modern people's lives more convenient. For instance, transportation equipment installed a PND can prevent a driver from going astray and assist the driver to reach the destination. Moreover, with the advance of technology, a PND further including functions such as route planning, AV (Audio-Video) playing, data storing, etc., help drivers to save time and provide recreations.

In producing an electronic device which includes map data or an operating system such as a smart phone, a PDA, a PND, etc., the map data and the operating system are often burned in a flash memory such as a moviNAND. The flash memory which includes the map data and the operating system is then mounted on the mother board of the electronic device by, for example, SMT (surface mount technology).

After assembling the electronic device, operators will determine the country or the region to where the electronic device will be shipped via the serial number and boot inspection, and pack the electronic device according to the country or the region. Moreover, after assembling the electronic device, the operators will perform the initial inspection to test whether the parameters (such as voltage, current, version number, FLASH, etc.,) of the electronic device comply with the specification of the electronic device. Furthermore, the operators also have to check whether the serial number on the product label and the serial number burned in the electronic device are consistent.

However, the above-mentioned inspection method requires a large amount of manpower. And, manual inspection spends more time, makes the efficiency worse, and easily induces misjudgment due to inspectors' different levels of expertise or tiredness. Moreover, defective products may be continuously packed and then launched to market due to misconduct.

### SUMMARY OF THE INVENTION

Accordingly, the aspect of the invention is to provide a system and a method of for inspecting an electronic device, and more particularly, to provide a system and a method for instantly inspecting an electronic device during production.

An embodiment of the invention discloses a system for inspecting an electronic device. The system includes a database, an inspecting server, a maintaining server, and a monitoring server. Moreover, the electronic device is capable of performing an inspecting program for measuring a plurality of inspecting parameters.

The database is used for storing a plurality of standard parameters related to the electronic device, and each standard parameter corresponds to one of the inspecting parameter respectively. The inspecting server is connected to the database and the electronic device respectively for receiving the standard parameters and the inspecting parameters, comparing each standard parameter with the corresponded inspecting parameter respectively, and setting a processing status of the electronic device according to a first criterion. The maintaining server is connected to the database for setting the standard parameters. The monitoring server, connected to the database, for receiving comparison results of the inspecting parameters and the standard parameters, and generating a piece of adjusting information according to the comparison results.

Another embodiment of the invention discloses a method for inspecting an electronic device. The method includes the steps of: (A) setting and storing a plurality of standard parameters of the electronic device; (B) measuring a plurality of inspecting parameters of the electronic device, and particularly, each inspecting parameter corresponding to one of the standard parameters; (C) comparing each inspecting parameter with the corresponded standard parameter respectively, and setting a processing status of the electronic device according to a first criterion; and (D) receiving comparison results of the inspecting parameters and the standard parameters, and generating an adjusting information according to the comparison results.

The advantage and spirit of the invention may be understood by the following recitations together with the appended drawings.

### BRIEF DESCRIPTION OF THE APPENDED DRAWINGS

FIG. 1 is a schematic diagram illustrating a system for inspecting an electronic device according to a first embodiment of the invention.

FIG. 2 is a schematic diagram illustrating a system for inspecting an electronic device according to a second embodiment of the invention.

FIG. 3 is a flow chart showing a method for inspecting an electronic device according to the first embodiment of the invention.

FIG. 4 is a flow chart showing a method for inspecting an electronic device according to the second embodiment of the invention.

### DETAILED DESCRIPTION OF THE INVENTION

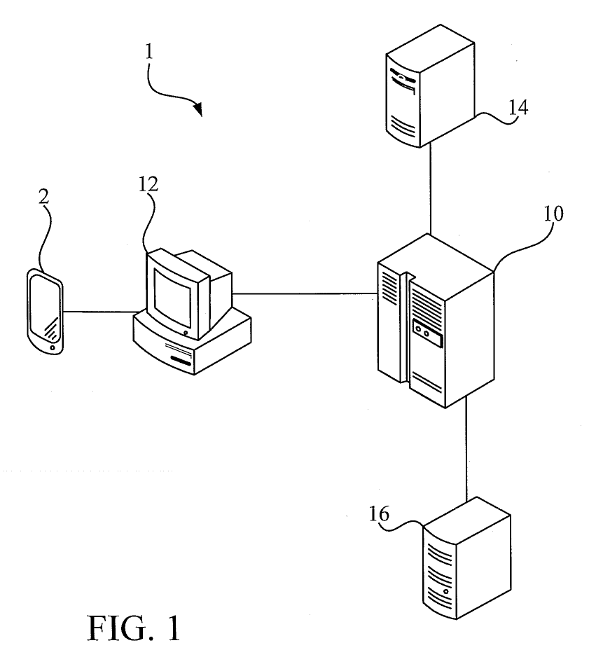

Please refer to FIG. 1. FIG. 1 is a schematic diagram illustrating a system 1 for inspecting an electronic device 2 according to an embodiment of the invention. As shown in FIG. 1, the system 1 according to the invention includes a database 10, an inspecting server 12, a maintaining server 14, and a monitoring server 16. Moreover, the electronic device 2 is capable of performing an inspecting program for measuring a plurality of inspecting parameters.

It is notable that the electronic device 2 recited by the invention can be, but not limited to, a PND (portable navigation device), a PDA (personal digital assistant), a mobile communication device, or a GPS (Global Positioning System)-based device (such as a GPS locating device). Moreover, the electronic device 2 includes a map data and/or an operating system. The map data and/or the operating system are burned in a memory member of the electronic device 2, such as a flash memory.

The database 10 is able to be used for storing a plurality of standard parameters related to the electronic device 2, and each standard parameter corresponds to one of the inspecting parameter respectively. The inspecting server 12 is connected to the database 10, for instance, over a wired network or a wireless network and the electronic device 2, for instance, via a universal serial bus (USB) respectively. The inspecting server 12 is capable of receiving the standard parameters and the inspecting parameters, comparing each standard parameter with the corresponded inspecting parameter respectively, and setting a processing status of the electronic device 2 according to a first criterion.

In a practical application, the plurality of standard parameters of the invention include, but not limited by, a voltage parameter, a current parameter, a serial number, a country parameter, a version number, a FLASH parameter, or other parameters.

In a practical application, the first criterion includes a definition that when the difference between at least one inspecting parameter of the inspecting parameters and the corresponded standard parameter exceeds a default value, the inspecting server 12 sets the processing status of the electronic device 2 as “FAIL.” For instance, when the difference between the voltage parameter of the inspecting parameters and that of the standard parameters exceeds the default value, the inspecting server 12 will set the processing status of the electronic device 2 as “FAIL.” Moreover, in a practical application, the first criterion includes a definition that the inspecting server 12 will set the processing status of the electronic device 2 as “PASS” when the differences between the inspecting parameters and the standard parameters do not exceed the default values.

The maintaining server 14 and the monitoring server 16 are connected to the database 10, for instance, over a wired network or a wireless network. The maintaining server 14 is able to be used for setting the standard parameters and storing the standard parameters into the database 10. The monitoring server 16 is capable of receiving comparison results of the inspecting parameters and the standard parameters from the database 10, and generating a piece of adjusting information according to the comparison results.

In a practical application, the adjusting information includes production parameter adjusting information. The production parameter adjusting information can be transmitted to the apparatus which produces the electronic device 2 or the engineers in the production line as a basis for adjusting the production parameter. For instance, when the production parameter adjusting information shows that the voltage value of several electronic device 2 are much higher, the engineers in the production line can adjust parameters of the related apparatus according to the adjusting information, so as to achieve the purpose of modifying.

In a practical application, the adjusting information still can include alert information. Similarly, the alert information can be transmitted to the engineers in the production line or the related managements. For instance, when the alert information shows that several inspecting parameters of a batch of electronic device 2 are abnormal, the engineers in the production line or the related managements can pause the production process and find out where is likely to make errors, so as to achieve the purpose of improving immediately.

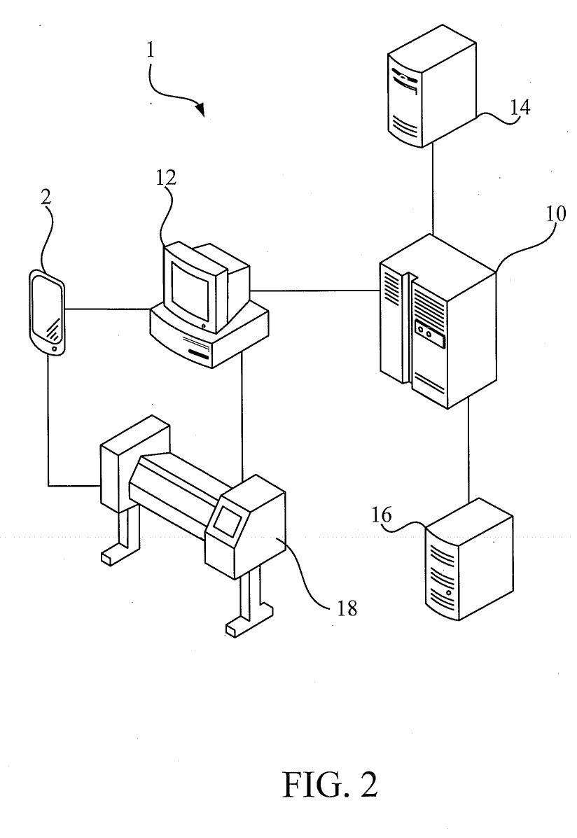

Please refer to FIG. 2. FIG. 2 is a schematic diagram illustrating a system 1 for inspecting an electronic device 2 according to an embodiment of the invention. As shown in FIG. 2, in the embodiment, the inspecting server 12 of the invention still includes a processing station 18.

The processing station 18 is connected to the inspecting server 12 and the electronic device 2 respectively and processes the electronic device 2 according to a country parameter and the processing status of the electronic device 2. In a practical application, the processing station 18 is a packing workstation, and is used for packing the electronic device 2. And in the practical application, the first inspecting parameter is a country parameter.

Hereby, the packing workstation is capable of printing a proper language on the outer packing of the electronic device 2 according to the country to be sold, or packing the compact disc of driver in a proper language with the electronic device 2 together.

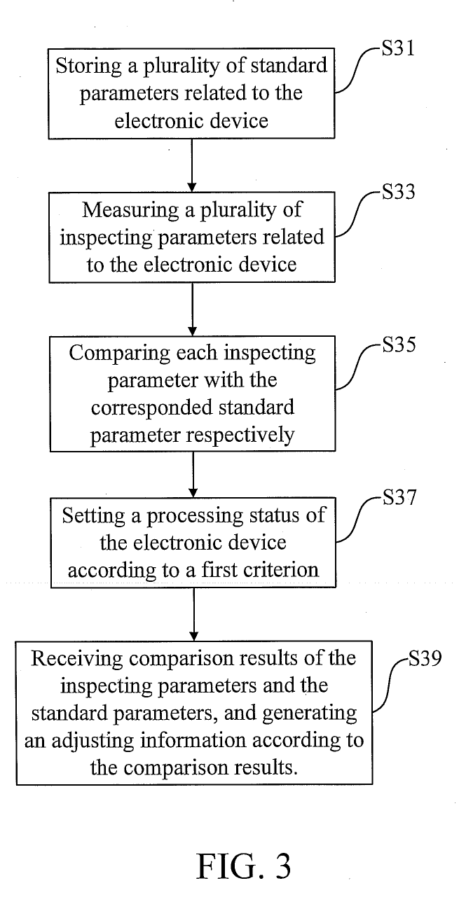

Please refer to FIG. 3. FIG. 3 is a flow chart showing a method for inspecting an electronic device 2 according to an embodiment of the invention. As shown in FIG. 3, the method according to the invention first includes step S31: storing a plurality of standard parameters of the electronic device 2. Then, the method includes step S33: measuring a plurality of inspecting parameters of the electronic device 2. Next, the method includes step S35: comparing each inspecting parameter with the corresponded standard parameter respectively. After that, the method includes step S37: setting a processing status of the electronic device 2 according to a first criterion. Finally, the method includes step S39: receiving comparison results of the inspecting parameters and the standard parameters and generating a piece of adjusting information according to the comparison results.

As recited above, the plurality of standard parameters of the invention can be, but not limited by, a voltage parameter, a current parameter, a serial number, a country parameter, a version number, a FLASH parameter, or other parameters. Moreover, the adjusting information can include production parameter adjusting information and/or alert information.

In a practical application, the first criterion includes a definition that when the difference between at least one inspecting parameter of the inspecting parameters and the corresponded standard parameter exceeds a default value, the inspecting server 12 sets the processing status of the electronic device 2 as “FAIL.” Moreover, in a practical application, the first criterion includes a definition that the inspecting server 12 will set the processing status of the electronic device 2 as “PASS” when the differences between the inspecting parameters and the standard parameters do not exceed the default values.

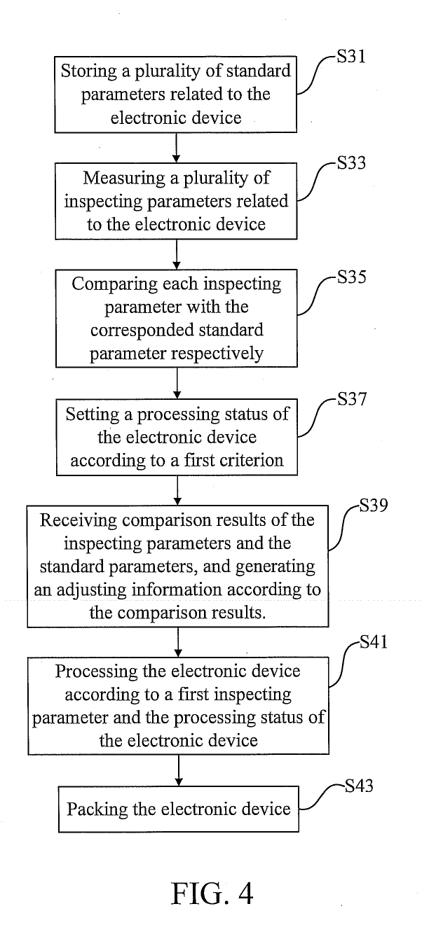

Please refer to FIG. 4. FIG. 4 is a flow chart showing a method for inspecting an electronic device 2 according to an embodiment of the invention. As shown in FIG. 4, the method according to the invention further includes step S41: processing the electronic device 2 according to a first inspecting parameter (such as the country parameter) and the processing status (such as PASS) of the electronic device 2. The method includes step S43: packing the electronic device 2.

To sum up, the system and the method according to the invention are able to reduce the manpower of inspectors and the consumed time. The system and the method of the invention are also able to improve the reliability and prevent from manually misidentifying. Particularly, the system and the method according to the invention are still able to maintain or modify the inspecting standards immediately, and feedback the product status to the production line as a basis for process improvement.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for inspecting an electronic device, the electronic device being capable of performing an inspecting program for measuring a plurality of inspecting parameters related to the electronic device, the system comprising:
a database storing a plurality of standard parameters related to the electronic device, and each standard parameter corresponding to one of the inspecting parameter respectively;
an inspecting server, connected to the database and the electronic device respectively, for receiving the standard parameters and the inspecting parameters, comparing each standard parameter with the corresponded inspecting parameter respectively, and setting a processing status of the electronic device according to a first criterion;
a maintaining server, connected to the database, for setting the standard parameters; and
a monitoring server, connected to the database, for receiving comparison results of the inspecting parameters and the standard parameters, and generating an adjusting information according to the comparison results.

2. The system of claim 1, further comprising a packing workstation, connected to the inspecting server and the electronic device respectively, for packing the electronic device according to a country parameter and the processing status of the electronic device.

3. The system of claim 1, wherein the inspecting server is connected to the electronic device via a universal serial bus.

4. The system of claim 1, wherein the plurality of standard parameters is any one combination selected from a group consisting of a voltage parameter, a current parameter, a serial number, a country parameter, a version number, and a FLASH parameter.

5. The system of claim 1, wherein the adjusting information comprises a production parameter adjusting information and/or an alert information.

6. The system of claim 1, wherein the electronic device is one selected from a group consisting of a portable navigation device, a personal digital assistant, a mobile communication device, and a GPS-based device.

7. The system of claim 1, wherein the electronic device comprises a map data and/or an operating system.

8. The system of claim 7, wherein the map data and/or the operating system are burned in a flash memory of the electronic device.

9. A method for inspecting an electronic device, the method comprising the steps of:
(A) setting and storing a plurality of standard parameters of the electronic device;
(B) measuring a plurality of inspecting parameters of the electronic device, wherein each inspecting parameter corresponds to one of the standard parameters;
(C) comparing each inspecting parameter with the corresponded standard parameter respectively, and setting a processing status of the electronic device according to a first criterion; and
(D) receiving comparison results of the inspecting parameters and the standard parameters, and generating an adjusting information according to the comparison results.

10. The method of claim 9, further comprising the step of:
(E) processing the electronic device according to a first inspecting parameter and the processing status of the electronic device.

11. The method of claim 10, further comprising the step of:
(E1) packing the electronic device.

12. The method of claim 10, wherein the first inspecting parameter is a country parameter.

13. The method of claim 9, wherein the plurality of standard parameters is any one combination selected from a group consisting of a voltage parameter, a current parameter, a serial number, a country parameter, a version number, and a FLASH parameter.

14. The method of claim 9, wherein the adjusting information comprises a production parameter adjusting information and/or an alert information.
